(19) United States
(12) Patent Application Publication
(10) Pub. No.: US 2007/0239663 A1
(43) Pub. Date: Oct. 11, 2007

(54) Parallel processing of count distinct values

(75) Inventor: Raymi Dyskant, Ypsilanti, MI (US)

Correspondence Address: PILLSBURY WINTHROP SHAW PITTMAN, LLP, P.O. BOX 10500, MCLEAN, VA, 22102, US

(73) Assignee: Clareos, Inc., Herndon, VA (US)

(21) Appl. No.: 11/398,596

(22) Filed: Apr. 6, 2006

(51) Int. Cl. G06F 17/30

(52) U.S. Cl. 707/2

(57) ABSTRACT

A system and method for efficiently determining the number of distinct values in a column of source data is disclosed. Source data (e.g., source table) may be in the form of rows and columns that represent information. From the source table a count distinct function may be carried out to determine the number of distinct values in one or more columns of the source table. Results from an in memory count distinct function performed by a plurality of parallel query processors may be placed into a results grid. Another aspect of the invention relates to determining how many distinct values fall into each cell of the results grid.

### FIELD OF THE INVENTION

The invention relates to a system and method for parallel processing of large amounts of data in order to count distinct values and for efficiently processing the data by using recursive splitting techniques to create chunks of data that fit within available memory.

### BACKGROUND OF THE INVENTION

In a wide variety of situations, data is stored in tables including records (rows) and fields (columns). The intersection of the rows and columns typically contain values. In some situations, other labels are used for the rows and columns, but the concepts are the same. For simplicity, the invention will be described using the terms rows and columns. However, the invention is not so limited. Given a table of rows and columns, it is often desirable to compute the number of distinct values in one or more columns. It is also desirable to determine how many distinct values fall into certain rows of a result grid (and how many in each plane, etc.).

Various techniques for performing a count distinct function are known. Prior approaches are generally inefficient and have other drawbacks. This is particularly true when the amount of source data is large. For example, where the data for the number of source data rows to be processed exceeds the capacity of available memory (e.g., RAM), it complicates the performance of a count distinct function. Other techniques are also not adapted for producing the number of distinct values into rows and columns of a results grid.

For some data processing applications, parallel query processors may be used to process large data sets. However, it is generally recognized that the use of prior art parallel processing for count distinct functions poses certain difficulties. The background of U.S. Pat. No. 6,430,550 acknowledges this.

U.S. Pat. No. 6,430,550 (which is incorporated herein by reference in its entirety) attempts to address this with a multi-step process that in some cases is performed by grouping by values other than the value upon which a count distinct function is to be performed. For example, with reference to FIG. 1 of that patent, if it is desired to perform a count distinct function for the number of distinct managers in each region, the process starts by grouping the rows by the region value. Then the process eliminates the rows that have duplicate manager values and then counts the number of rows remaining in each region group.

There are several drawbacks with this approach. Among the drawbacks is that the second stage processes are not sorted in an effective way and there is no recursive splitting of the sections with respect to memory. This is particularly an issue when the number of rows is large relative to the amount of memory. Other drawbacks related to memory (e.g., RAM) size may arise when performing count distinct on large amounts of data. In general, large amounts of data may slow down overall processing of count distinct functions and lower performance. These and other drawbacks exist in prior systems and approaches.

There is a need for efficiently computing count distinct values for large amounts of data while preventing performance degradations and respecting available memory.

### SUMMARY OF THE INVENTION

Various aspects of the invention overcome at least some of these and other drawbacks of known systems. One aspect of the invention relates to a system and method for determining the number of distinct values in a column of source data. Source data (e.g., source table) may be in the form of rows and columns that represent information. For example, a source table may be data representing the number of sales transactions in a given month. From the source table a count distinct function may be carried out to determine the number of distinct values in one or more columns of the source table. The one or more columns on which the count distinct is calculated may be collectively referred to as analytic column.

Results from count distinct function may be placed into a results grid. Another aspect of the invention relates to determining how many distinct values fall into each cell of the results grid. A cell may be the intersection of a row and column within the results grid. A cell may represent a row or rows of data from a source table.

Given an analytic column, there are a number of ways of determining, for each row, which cell in a result grid it falls into. The determination may be based on rearranging source data into a result grid such that a row of source data is represented by a cell of the result grid. Accordingly, each cell may contain count distinct results. Furthermore, a hash table may be created by pairing the value from the source data with its respective cell (e.g., using cell identifier) from a result grid. A cell may include one or more values based on the analytic column, which are used to create the hash table of cell-value pairs. Thus, each cell-value pair is comprised of the value of the analytic column at a particular row of the source table, and the cell that the row corresponds to.

One aspect of the invention relates to recursively splitting the data into chunks small enough to ensure that the chunks can fit into memory (after hashing). According to another aspect of the invention, the system determines which data goes into which chunks based on the value from the cell-value pairs. According to one aspect of the invention, the same value does not appear in two different chunks. Thus, in the example above, instead of grouping by region, the initial splitting of the data is based on the values of the cells in the analytic column (the managers in the example above). To the extent that an initial pass would result in a set of data being allocated such that the data set is too large to fit into an available memory, the data set is recursively split until each of the data sets is of a size suitable to fit into available memory, again ensuring that no value appears in two or more chunks.

Since no value of the analytic column appears in more than one chunk, each chunk can be treated as a separate problem and the system can use parallel processing to perform a count distinct function on each chunk, and then simply add the results together. Other advantages result from this approach. One advantage occurs when it is desired to address multidimensional problems as detailed below.

As indicated above, according to one embodiment, multiple query processors can operate in parallel simultaneously. The operation of each processor may include the following steps.

In a first stage, the system splits a data set into a number of chunks based on the value in a column upon which a count distinct function is to be performed (analytic column), such that no value appears in two or more chunks. A cell identifier may be paired with each value. One or more processors of the system arranges cell-value pairs having the same value into the same chunks, thus rows of the source data that have the same analytical values (value in analytical column) go into the same chunk. Each chunk may be stored as an output file. Then in a second stage, the system determines if each chunk is of a size that can be fit into available memory. If not, the system recursively splits the data into additional chunks until each chunk fits into available memory. Then in a third stage, the system does an in memory count distinct on each chunk and adds the results.

Determining the splits by value, and sorting them, allows summary cells to be computed effectively, and also facilitates the parallelization within the in-memory processing stage, in contrast to prior art techniques.

These and other objects, features and advantages of the invention will be apparent through the detailed description of the embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is a high-level block diagram for a system, according to one embodiment of the invention.

FIG. 2 is a functional block diagram illustrating aspects of one embodiment of the invention.

FIG. 3 is a flow diagram for a count distinct method, according to one embodiment of the invention.

### DETAILED DESCRIPTION OF THE INVENTION

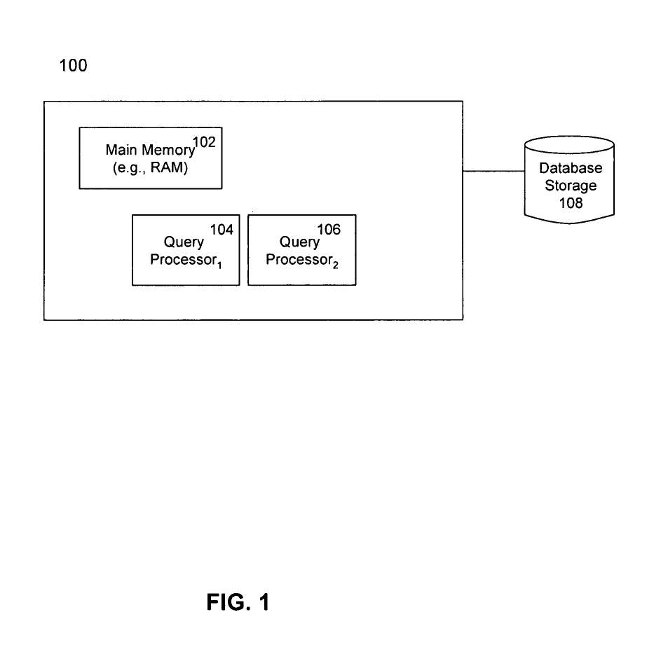

A system of the present invention may be implemented according to parallel operations carried out by a set of processors responsible for performing operations associated with the invention. As shown in FIG. 1, by way of example, a relational database system 100 may store one or more data records to be processed in main memory 102. Database storage 108 may provide storage space. In a relational database system the data may be referred to as tables. Tables may include records and fields. Records may be referred to as rows and fields may be referred to as columns. According to an embodiment of the invention, a relational database system may comprise at least a main memory 102 (e.g., RAM) and two or more query processors (104, 106) among other things, for carrying out a method of the invention. Data may be written to and/or read from main memory 102. The query processors (104, 106) may process data from main memory 102. The plurality of query processors may perform operations simultaneously to each other. Additionally, each query processor may have its own memory (not shown). Although FIG. 1 shows two query processors, it should be understood that any number of query processors may be utilized without leaving the scope of the invention.

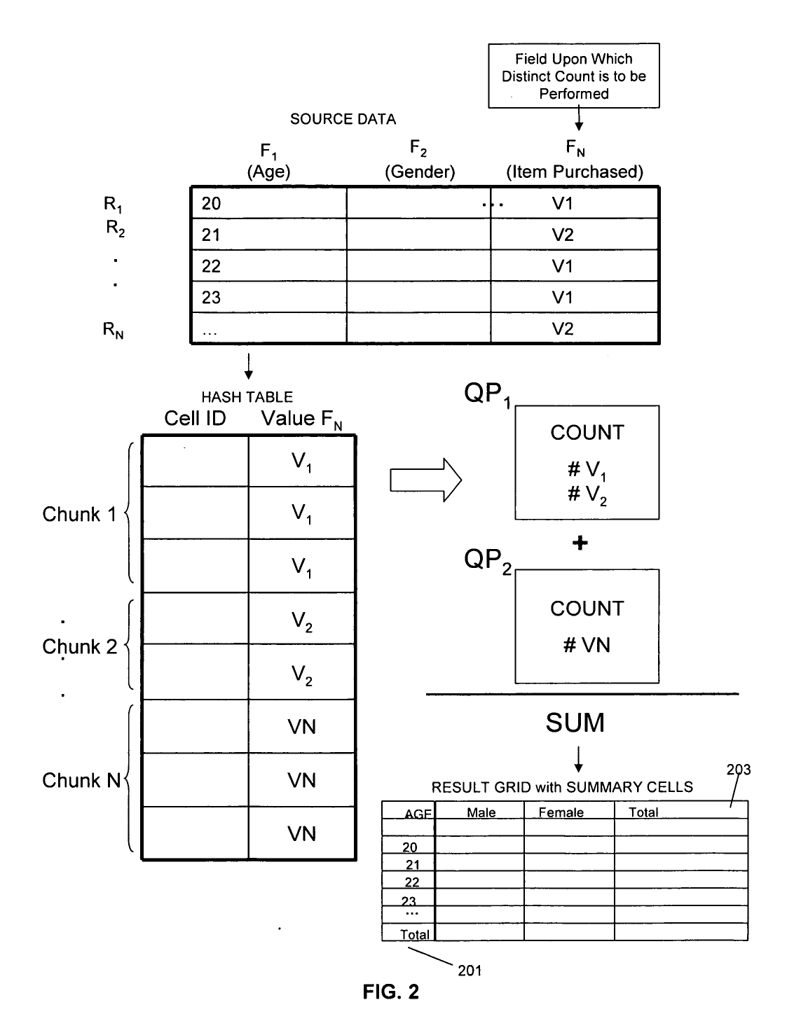

The invention includes source data which is arranged in rows and columns (e.g., within relational database system main memory). Source data may be in the form of a table having one or more rows and one or more columns of values. A count distinct function may be carried out based on the values within any, all, or selected ones of the columns in each row, referred to collectively as the analytic column. FIG. 2 depicts a logical flow of source data to the plurality of query processors. The source data, also referred to as source table, may include multiple records or rows (R1, R2, . . . RN) and multiple fields or columns (F1, F2, . . . FN). By way of example, FIG. 2 illustrates source data as a number of transactions, which simply illustrates three columns (or fields) labeled as Age, Gender, and Item Purchased. Though only one column is selected in the figure, more than one column may be selected for which a count distinct operation should be performed. The one or more selected columns may be referred to collectively as analytic column.

The values in the analytic column may be associated with a cell of a result grid. A result grid as shown in FIG. 2, by way of example, is an arrangement of the source data such that a source data row is represented by an entry (or cell) within the result grid. Each entry in the result grid may be referred to as a cell. The cell is an intersection of a row and column in a result grid. The result grid may be created in any number of ways and how each source data row is assigned a cell in the grid is not of particular concern to the invention, as long as it is consistent throughout. A cell in a result grid may display the number of distinct values in the analytic column from the plurality of source data rows. Each cell may be identified using any convenient means for labeling the cell (e.g., cell number, cell letter, cell symbol, coordinate, name, etc.) From this, each value in the analytic column is paired with its respective cell identifier from the result grid. Each pairing may also be referred to as a cell-value pair.

A hash table of cell-value pairs as shown in FIG. 2 may be created from the analytic column value coupled to its corresponding cell. In FIG. 2 by way of example, the analytic column is “Item Purchased.” Although only one column is part of the analytic column, other embodiments may include more than one column collectively referred to as the analytic column. The hash table is completed by creating cell-value pairs for all (or selected) rows of source data or until available memory for the hash table has run out. As shown in FIG. 2, cell-value pairs are placed into the hash table. If at any time the hash table completes all the source data rows or if the hash table outgrows memory, the cell-value pairs may be saved to one of a multiple number of output files based on the value.

The cell-value pairs are written to output files as “chunks,” where the chunks are based on the value of the cell-value pair. One or more chunks may be stored to an output file. A number of chunks small enough to be properly processed by a query processor may be created. Each available query processor (QP1, QP2, . . . QPN) receives one or more chunks of data and performs count distinct functions on the chunk. The count distinct result from each query processor (QP1, QP2 . . . ) on each chunk of data may be added in order to obtain an overall count distinct value. The overall count distinct totals may be represented in summary cells related to a result grid, as shown by way of example in FIG. 2. As detailed below, the chunks are created in a way to insure that no value from the cell-value pairs appears in two different chunks. Additionally, if any chunk is larger than the available processor memory, a recursive split by value may be used. This is to ensure that the same value does not show up in more than one chunk.

The results grid may have multiple summary cells and result vectors. In the example of FIG. 2 the column and row of the results grid labeled “total” (201 and 203, respectively) are the result vectors of the summary cells. Each summary cell grouped by gender (201) and age (203) may include each distinct value or the number of distinct values, which in this example is each distinct item purchased. For example, cell Male/22 would be the number of distinct items purchased (or listing of distinct item(s) purchased) by 22 year old males. The Total/25 cell would be the number of distinct items purchased (or listing of distinct item(s) purchased) by 25 year olds. As discussed above, each row from the source table is a cell corresponding to the distinct values of “items purchased” by gender and age. The Total/Total cell will contain the number of distinct items purchased by anybody. Each cell will contribute to 2ⁿ⁻¹ summary cells, where n is the number of dimensions of the results grid. The results grid may be any number of dimensions.

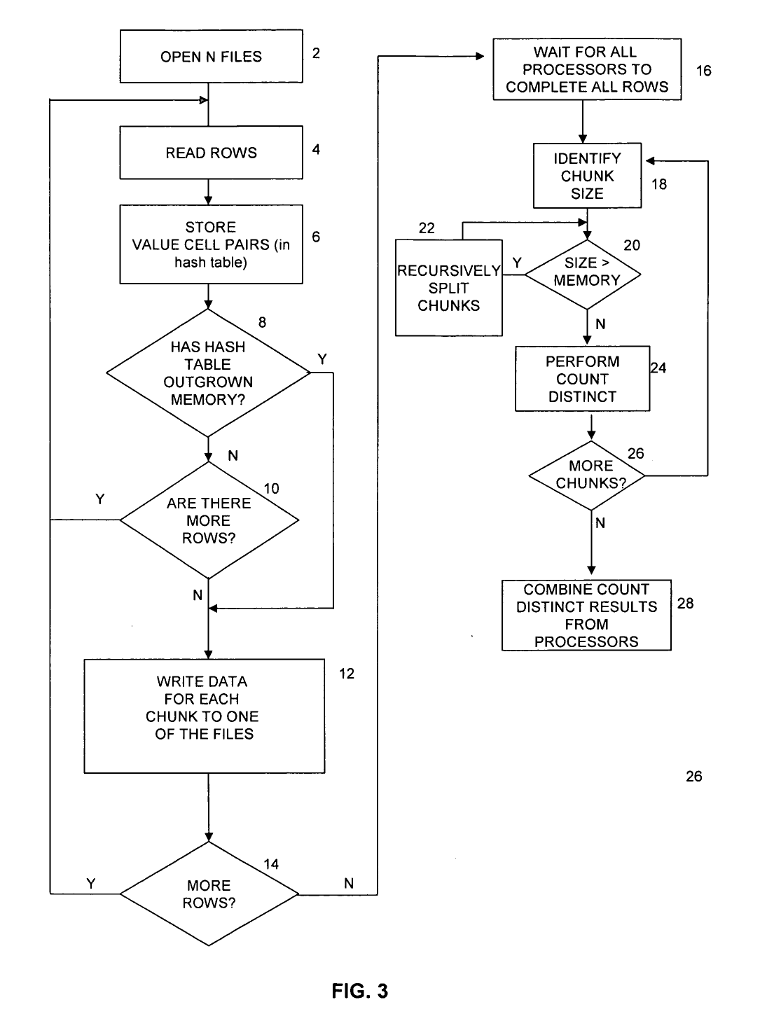

FIG. 3 is a flow chart illustrating a method according to one aspect of the invention. One or more query processors may each perform the operations of the method described below. The process may begin by opening a number (N) of output files (operation 2). The output files may be created and/or opened based on one or more of a number of unique values in one or more source tables that are being processed; the number of query processors available; and/or other information. A number of rows from a source table, e.g. as illustrated in FIG. 2, are read (operation 4). Data from the rows are written to a hash table including cell-value pairs (operation 6). If it is determined that the hash table has outgrown available memory (operation 8) the chunks may be written to one of the output files (operation 12). Chunks of cell-value pairs are stored to output files such that no value is present in more than one chunk. However, a chuck may span over more than one file. If it is determined that the hash table has not outgrown memory (operation 8), then control passes to operation 10. In operation 10, the system determines whether there are more source data rows to process. If yes, control passes back to operation 4. If not, control passes to operation 12. In operation 12, data for each chunk is written to one of the output files (operation 12), as discussed above more than one chunk may be written to one file. Then, the system determines if there are still more rows to process (operation 14). If so, control passes back to operation 4. If not, control passes to operation 16.

In operation 16, the system waits for all query processors of the system to complete operations 2-14 with no more source data rows remaining. Once all query processors have reached this point operation 18 determines the chunk sizes. To effectively process potentially large amounts of data, each chunk size is compared to the available query processor memory size (operation 20). If a chunk is too large for an available memory, a recursive split of the chunks may be performed until the chunk(s) is (are) of a size to fit available memory (operation 22). Recursive split techniques per se are known in the preferred embodiment, the recursive splitting is done in a way to ensure that no value appears in more than one chunk. Once a chunk is properly sized according to available processor memory, the processor may perform an in memory count distinct operation (operation 24). The processor may determine whether another chunk is available to process (operation 26). If so, control passes back to operation 18. If not, the count distinct results from each processor may be added to obtain the overall count distinct value (operation 28). A results grid may be used to represent the overall information using summary cells. The results may be stored, output, displayed or otherwise used.

Thus, according to one aspect of the invention the count distinct values for effectively organizing and displaying data may be determined using an algorithm having at least three parts. First, one or more selected rows may be hashed, according to cell-value pairs, into a hash table. The system takes each cell-value pair and puts it in a hash table. The process of hashing and writing to an output file is repeated until no more rows are left to consider. Once the size of the hash table outgrows available memory or all the rows have been hashed, each cell-value pair may be written as chunks of data to one or more of the output files, such that no two chunks have the same value from the cell-value pair stored within them. As a result, all cell-value pairs with the same value are stored within only one output file as a chunk. As described above, more than one chunk may be stored in an output file. This enables a count distinct function to be easily performed.

Second, one or more query possessors can process the chunks by opening one or more output files as needed to process at least one chunk. The chunk(s) within the one or more files of data are recursively split until no chunk is too big for the query processors. Third, the in-memory count distinct computation can be done by any algorithm desired. For example, given a chunk of data the cell value pairs may be inserted into hash table, different from the hash table shown in FIG. 2. Then a rehash by value may be performed so that the cell-value pairs with the same value are in consecutive order. Then the query processor can walk this hash table. For each cell-value pair encountered the results grid is incremented at the appropriate cell, and all associated summary cells (e.g., 201 and 203) with the value from the pair are updated. Each distinct (e.g., unique) value encountered may be used to increment the cells. If the value is not distinct then the cell is not incremented. A plurality of query processors perform count distinct on all the chunks of data. The results from each processor may be simply added up to calculate overall count distinct information according to the description above.

According to one embodiment, as each processor completes a count distinct function, the query results (e.g., count distinct results) may be added to summary cells. The summary cell may display each unique value associated with a result vector and/or the number of distinct values associated with a result vector (count-distinct results). For example, each unique cell-value pair encountered in the hash table walk for a particular value will increment the cell in the result grid by one.

A number of query processors can perform the process simultaneously with each other. This parallel processing provides added efficiency in time and accuracy to the overall system.

According to another aspect of the invention, the hashing in the first step may not be executed, and in some cases it may not be desirable, but most of the time, and for large sized data relative to available memory, it helps get the chunks down to a manageable size with fewer splits.

In the foregoing specification, the invention has been described with reference to specific embodiments thereof. Various modifications and changes may be made thereto without departing from the broader spirit and scope of the invention. The specification and drawings are, accordingly, to be regarded in an illustrative rather than a restrictive sense.

1. A method for performing a count distinct function on values in at least one column of data comprising:
a) splitting the data into chunks based on the values in the at least one column of data upon which the count distinct function is to be performed, where no value appears in more than one chunk;
b) determining if each chunk is of a size that enables it to fit into available memory, and
i) if not, recursively splitting the oversized chunks until each chunk is of a size that enables it to fit into available memory; and
c) performing an in memory count distinct function on each chunk and summing a number of distinct values from each chunk for display in at least one cell of a results grid.

2. The method of claim 1, wherein the at least one cell of the results grid represents one or more rows of the at least one column of data.

3. The method of claim 1, further comprising hashing the data in at least one column of data according to value before splitting the data into chunks.

4. The method of claim 1, wherein a number of cells is 2ⁿ⁻¹, wherein n is a number of dimensions of the results grid.

5. The method of claim 1, wherein the in-memory count distinct function further includes hashing the data in the chunks by value.

6. A method for performing a count distinct function on values in at least one column of data from source data having at least one or more rows and one or more columns, comprising:
a) assigning a row of the source data to a cell in a grid
b) creating a hash table based on a value in a column of the row and the cell assigned to the row;
c) splitting the hash table of cell-value pairs into chunks based on the values, where no value appears in more than one chunk;
b) determining if each chunk is of a size that enables it to fit into available memory, and
i) if not, recursively splitting the oversized chunks until each chunk is of a size that enables it to fit into available memory; and
c) performing an in memory count distinct function on each chunk and summing a number of distinct values from each chunk for display in at least one cell of a results grid.

7. The method of claim 6, wherein the at least one cell of the results grid represents one or more rows of the at least one column of data.

8. The method of claim 6, wherein a number of cells is 2ⁿ⁻¹, wherein n is a number of dimensions of the results grid.

9. The method of claim 6, wherein the in-memory count distinct function further includes creating another hash table for in the chunks by value.

10. A relational database system having data storage and one or more processors for performing a count distinct function on values in at least one column of data comprising:
a) means for splitting the data into chunks based on the values in the column(s) of data upon which the count distinct function is to be performed so that no value appears in more than one chunk;
b) means for determining if each chunk is of a size that enables it to fit into available memory, and
i) if not, recursively splitting the chunks until each chunk is of a size that enables it to fit into available memory; and
c) means for performing an in memory count distinct function on each chunk and summing a number of distinct values from each chunk for display in at least one cell of a results grid.

11. The system of claim 10, wherein the at least one cell of the results grid represents one or more rows of the at least one column of data.

12. The system of claim 10, further comprising means for hashing the data in at least one column of data according to value before splitting the data into chunks.

13. The system of claim 10, wherein a number of cells is 2ⁿ⁻¹, wherein n is a number of dimensions of the results grid.

14. The system of claim 10, wherein the means for performing an in-memory count distinct function further includes means for hashing the data in the chunks by value.

15. A relational database system having data storage and one or more processors for performing a count distinct function on values in at least one column of data from source data having at least one or more rows and one or more columns, comprising:
a) means for assigning a row of the source data to a cell in a grid
b) means for creating a hash table based on a value in a column of the row and the cell assigned to the row;
c) means for splitting the hash table of cell-value pairs into chunks based on the values, where no value appears in more than one chunk;
b) means for determining if each chunk is of a size that enables it to fit into available memory, and
i) if not, a means for recursively splitting the oversized chunks until each chunk is of a size that enables it to fit into available memory; and
c) means for performing an in memory count distinct function on each chunk and summing a number of distinct values from each chunk for display in at least one cell of a results grid.

16. The system of claim 15, wherein the at least one cell of the results grid represents one or more rows of the at least one column of data.

17. The system of claim 15, wherein a number of cells is 2ⁿ⁻¹, wherein n is a number of dimensions of the results grid.

18. The system of claim 15, wherein the in-memory count distinct function further includes means for creating another hash table for the chunks by value.
